(19) United States
(12) Patent Application Publication
(10) Pub. No.: US 2024/0274108 A1
(43) Pub. Date: Aug. 15, 2024

(54) Composite Molded Body, Method for Manufacturing Same, and Composite Sound Absorbing Material

(71) Applicant: Asahi Kasei Kabushiki Kaisha, Tokyo (JP)

(72) Inventor: Hirotaka Asai, Tokyo (JP)

(73) Assignee: Asahi Kasei Kabushiki Kaisha, Tokyo (JP)

(21) Appl. No.: 18/567,160

(22) PCT Filed: Jun. 7, 2022
(86) PCT No.: PCT/JP2022/022999

§ 371 Date: Dec. 5, 2023

(30) Foreign Application Priority Data
Jun. 9, 2021 (JP) 2021-096643

(51) Int. Cl. G10K 11/168

(52) U.S. Cl. CPC G10K 11/168; G10K 2210/3219; G10K 2210/3223

(57) ABSTRACT

The purpose of the present disclosure is to provide a composite molded body that can be suitably used as a ventilation adjustment layer having excellent sound absorbability between a low frequency band and an intermediate frequency band, and has excellent three-dimensional shapeability. According to the present disclosure, a composite molded body including fibrillated fibers and short fibers is provided. The composite molded body has a surface density of 30 g/m² to 1000 g/m² and an air resistance of 15.0 s/(100 mL·mm) or less per unit thickness. According to the present disclosure, a composite sound absorbing material with a thickness of 10 mm or less in which a ventilation adjustment layer and a porous material are stacked is also provided.

### FIELD

The present disclosure relates to a composite molded body and a method for producing it, and to a composite sound absorbing material.

### BACKGROUND

Traveling of an automobile generates various forms of noise including noise from the engine or drive system, road noise, and wind noise. Sound-absorbing materials have conventionally been used for the purpose of inhibiting noise emission in order to suppress such unwanted noise and create comfortable indoor automobile spaces. With advances in electric vehicles in recent years, and particularly with increasingly quiet drive systems, sounds that had not previously been considered to be noise have come to be recognized as noise.

The frequency of noise depends on the sound source, and sound-absorbing materials suitable for different sound sources must therefore be used. However, porous sound-absorbing materials that are commonly used in vehicles, such as nonwoven fabrics and foam, while exhibiting an excellent sound absorption coefficient in the high frequency range, tend to have a smaller sound absorption coefficient at the low frequency end. Still, it is known that if a layer that modifies air permeability (hereunder referred to as “air permeability-modifying layer”) is provided on the surface of the porous material, the sound absorption property is improved across the low frequency to mid frequency range.

For example, PTL 1 describes a textile-type composite sound absorbing material having a foam layer provided as an air permeability-modifying layer on a nonwoven fabric obtained by combining staple fibers of specific fineness, the material exhibiting an excellent sound absorption property at 800 Hz to 2000 Hz.

PTL 2 discloses a composite sound absorbing material having a spunbond nonwoven fabric spot-bonded on a melamine foamed body using a hot-melt adhesive, and teaches that an excellent sound absorption property is exhibited in all frequency ranges if the thickness is slightly greater than 10 mm.

### CITATION LIST

### Patent Literature

[PTL 1] Japanese Unexamined Patent Publication No. 2018-154113
[PTL 2] International Patent Publication No. WO2017/006993

### SUMMARY

### Technical Problem

Due to inadequate functioning of air permeability-modifying layers in the prior art, however, they have resulted in increased overall thicknesses of sound-absorbing materials, or else despite exhibiting excellent function as air permeability-modifying layers, they have had poor shapeability and have been unable to follow complex three-dimensional shapes such as automobile parts.

It is one object of the present disclosure to provide a composite molded body that can be suitably used as an air permeability-modifying layer to provide excellent sound absorption properties across the low frequency to mid frequency range, and that has excellent three-dimensional shapeability.

### Solution to Problem

The following [1] to [10] are examples of embodiments of the disclosure.
[1]
A composite molded body comprising fibrillated fibers and staple fibers, wherein the composite molded body has a surface density of 30 g/m² to 1000 g/m² and an air permeability resistance per unit thickness of 15.0 s/(100 mL·mm) or lower.
[2]
The composite molded body according to [1] above, wherein the fibrillated fibers are one or more types selected from the group consisting of cellulose fine fibers, polyacrylonitrile fibrillated fibers, aramid pulp, chitin nanofibers, chitosan nanofibers and silk nanofibers.
[3]
The composite molded body according to [2] above, wherein the fibrillated fibers comprise cellulose fine fibers, and the cellulose fine fibers have a mean fiber size of 10 nm to 1000 nm, including microfibrous portions up to fibrillated ends.
[4]
The composite molded body according to any one of [1] to [3] above, wherein the staple fibers are composed of synthetic fibers.
[5]
A method for producing a composite molded body according to any one of [1] to [4] above, wherein the method includes a step of three-dimensional shaping of a slurry comprising fibrillated fibers and staple fibers, by a pulp molding method.
[6]
A sound absorbing material comprising a composite molded body according to any one of
[1] to [4] above.
[7]
A composite sound absorbing material comprising a support having a thickness of 5 mm or greater, and a composite molded body according to any one of [1] to [4] above, layered on the support.
[8]
The composite sound absorbing material according to [7] above, wherein the support is a porous material.
[9]
A composite sound absorbing material having a structure in which an air permeability-modifying layer and a porous material are layered, wherein:
the composite sound absorbing material has a thickness of 10 mm or smaller, and
in the method of measuring the normal incidence according to JIS A 1405, the material has a maximum for sound absorption at 3000 Hz or lower, a sound absorption coefficient of 0.3 or greater for 1000 Hz, an average sound absorption of 0.4 or greater for 800 Hz to 2000 Hz and an average sound absorption of 0.3 or greater for 500 Hz to 6400 Hz.
[10]
A composite sound absorbing material having a structure in which an air permeability-modifying layer and a porous material are layered, wherein:
the composite sound absorbing material has a thickness of 10 mm or smaller,
the air permeability-modifying layer has a surface density of 100 g/m² to 1000 g/m²
the air permeability-modifying layer has an air permeability resistance of 0.1 s/100 mL to 2.0 s/100 mL,
the air permeability-modifying layer has a thickness of 0.50 mm to 5.00 mm, and
the porous material has a thickness of 5.00 mm or greater.

### Advantageous Effects of Invention

The composite molded body of the present disclosure can be suitably used as an air permeability-modifying layer to provide excellent sound absorption properties across the low frequency to mid frequency range, and has excellent three-dimensional shapeability.

### BRIEF DESCRIPTION OF DRAWINGS

FIG. 1 is a graph showing the results of sound absorption coefficient measurement for Example 1-1, Example 1-7, Example 1-10 and Comparative Example 1-1.

FIG. 2 is a graph showing the results of sound absorption coefficient measurement for Example 2-2, Example 2-8 and Comparative Example 2-1.

FIG. 3 is a schematic diagram representing the positions of a three-dimensional composite sound absorbing material, a sound source and a desk, in a method for evaluating the sound absorption property of a three-dimensional composite sound absorbing material.

FIG. 4 is a schematic view showing a longitudinal section of FIG. 3.

FIG. 5 is a schematic diagram representing a method for evaluating the sound absorption property of a three-dimensional composite sound absorbing material.

FIG. 6 is a schematic diagram representing a method of molding a composite molded body by a pulp molding method.

### DESCRIPTION OF EMBODIMENTS

Embodiments of the disclosure will now be explained in detail. It is to be understood, however, that the disclosure is not limited to these embodiments.

### Composite Molded Body

The composite molded body of the disclosure comprises fibrillated fibers and staple fibers, and has a surface density of 30 g/m² to 1000 g/m² and an air permeability resistance per unit thickness of 15.0 s/(100 mL·mm) or lower.

The composite molded body preferably has a structure in which staple fibers and fibrillated fibers are molded in a chemically or physically intertwined or mutually bonded state. The composite molded body has extremely low air permeability resistance since the dense structure has fine fiber gaps. When sound infiltrates through the gaps between the fibers, therefore, the composite molded body converts the vibrational energy of sound to friction with the ultrafine fibers, converting it to heat energy, while the composite molded body itself also undergoes membrane vibration, allowing further conversion to heat energy, so that it exhibits an excellent sound absorption property.

### Fibrillated Fibers

The composite molded body of the disclosure comprises fibrillated fibers. As used herein, the term “fibrillated fiber” refers to fibers having at least a partially branched structure. Fibrillated fibers are largely classified into two types: fibers that have been obtained by partially fracturing the structure of fibers without branch structures by using physical or chemical means, and fibers that have been fibrillated by intentionally creating fluff during spinning of the polymer compound. Examples of the former include microfibrillated cellulose (synonymous with CNF, cellulose nanofibers or cellulose fine fibers), synthetic pulp such as acryl pulp (fibrillated fibers of polyacrylonitrile) or aramid pulp, chitin nanofibers, chitosan nanofibers and silk nanofibers. An example of the latter is synthetic pulp produced by flash-spinning. Fibrillated fibers generally have a structure with partially narrowed fiber sizes compared to ordinary fibers without a branched structure, due to the method for their production. Fibrillated fibers consequently have larger surface area while also tending to have more of a curved structure. The fibrillated fibers in the composite molded body of the disclosure consequently exhibit an effect as a binder for joining together staple fibers by physical entanglement. Partially narrowed fibers help to adjust the air permeation of the composite molded body as a whole while contributing to sound absorption in the low frequency range. Depending on the type of fibrillated fibers, differences in the fibrillation rate and fiber sizes and the surface condition can potentially affect the properties of the composite molded body, but they preferably exhibit greater function as a binder while minimally inhibiting air permeation. From this viewpoint, the fibrillated fibers are preferably at least one type selected from the group consisting of microfibrillated cellulose, acrylic pulp, aramid pulp, chitin nanofibers, chitosan nanofibers and silk nanofibers, and more preferably at least one type selected from the group consisting of microfibrillated cellulose and acrylic pulp made of polyacrylonitrile. Cellulose obtained from a cellulose starting material with a type II crystal structure is preferably used for microfibrillated cellulose, because the air permeability resistance per unit thickness, as described in detail below, will be lower.

### Fibrillation Rate of Fibrillated Fibers

The fibrillation rate of the fibrillated fibers in the composite molded body is preferably 0.3% or higher. Within this range the effect as a binder will be sufficient, and the composite molded body will have a free-standing property, with low shedding of staple fibers from the composite molded body. Fibers narrowed by fibrillation also exhibit an effect of sound absorption in the low frequency range. The fibrillation rate of the fibrillated fiber is more preferably 0.5% or higher. The upper limit for the fibrillation rate is not particularly restricted but may be 100% or lower.

### Area Fineness of Fibrillated Fibers

The area fineness of the fibrillated fibers in the composite molded body is preferably 3.0% to 90%. Within this range the effect as a binder will be sufficient, and the composite molded body will have a free-standing property, with low shedding of staple fibers from the composite molded body. The area fineness of the fibrillated fibers is more preferably 5% to 50% and even more preferably 5% to 20%.

### Mean Fiber Length of Fibrillated Fibers

The mean fiber length of the fibrillated fibers in the composite molded body is preferably 150 μm or greater. Within this range the effect as a binder will be sufficient, the sizes of pores formed in the composite molded body will not be too small, and suitable air permeability will be obtained. The mean fiber length of the fibrillated fibers is more preferably 200 μm or greater, even more preferably 250 μm or greater and most preferably 350 μm or greater. The upper limit for the mean fiber length is preferably 1000 μm or smaller in order to obtain excellent miscibility with staple fibers and a homogeneous molded article, and it is more preferably 750 μm or smaller and even more preferably 500 μm or smaller. The mean fiber length was measured using a fiber image analyzer (Morfi-Neo by TechPap Co.), with a normal fiber/fine fiber threshold of 100 μm.

### Mean Fiber Size of Fibrillated Fibers by Method A

The mean fiber size of the fibrillated fibers in the composite molded body is primarily either the mean fiber size corresponding to trunk fiber portions of the fibrillated fibers (mean fiber size by Method A), or the mean fiber size including the microfibrous portions up to the fibrillated ends (mean fiber size by Method B). The mean fiber size by Method A is preferably 50 μm or smaller. Within this range, the sizes of pores formed in the composite molded body will not be too small, and suitable air permeability will be obtained. The mean fiber size of the fibrillated fibers by Method A is more preferably 30 μm or smaller, even more preferably 25 μm or smaller and most preferably 15 μm or smaller. The lower limit is not particularly restricted and may be 1.5 μm or greater for resolving power of the apparatus.

### Mean Fiber Size of Fibrillated Fibers by Method B

The mean fiber size by Method B is preferably 1000 nm or lower. Within this range, entanglement with the staple fibers will be more likely to occur, helping to inhibit shedding of the fibers from the composite molded body. The mean fiber size of the fibrillated fibers as a whole by Method B is more preferably 800 nm or smaller, even more preferably 600 nm or smaller and most preferably 500 nm or smaller. The lower limit is not particularly restricted but is preferably 10 nm or greater, more preferably 20 nm or greater and even more preferably 30 nm or greater.

### Microfibrillated Cellulose

According to a preferred aspect, the fibrillated fibers used in the composite molded body are microfibrillated cellulose. Cellulose fine fibers are cellulose fibers that have been micronized using at least one type of physical means, and the term is a generally synonymous with cellulose nanofibers, CNF, CeNF and MFC (microfibrillated cellulose).

### Cellulose Starting Material

The starting material for microfibrillated cellulose may be a type I cellulose starting material, which includes wood pulp such as conifer pulp or hardwood pulp, and nonwood pulp. Nonwood pulp may be cotton pulp such as cotton linter pulp, or hemp pulp, bagasse pulp, kenaf pulp, bamboo pulp or straw pulp. Cotton pulp, hemp pulp, bagasse pulp, kenaf pulp, bamboo pulp and straw pulp are the refined pulp obtained from the respective starting materials of cotton lint, cotton linter, hemp abaca (usually from Ecuador or the Philippines), sisal, bagasse, kenaf, bamboo and straw, by refining steps such as delignification by digestion treatment and hemicellulose removal, and bleaching steps. Purified products of seaweed cellulose or sea squirt cellulose may also be used as starting materials for cellulose fine fibers. Type II cellulose starting materials include cut yarns of regenerated cellulose fiber and cut yarns of cellulose derivative fibers, for use as cellulose fine fiber starting materials, and cut yarns of regenerated cellulose or cellulose derivative superfine fibers obtained by electrospinning methods, for use as cellulose fine fiber starting materials or for cellulose fine fibers themselves. Such starting materials may be used alone or in mixtures of two or more different types. The mean fiber size can be adjusted by using multiple different starting materials in admixture.

### Method for Producing Microfibrillated Cellulose

The starting material may be micronized to obtain microfibrillated cellulose. As used herein, “micronization” means controlling the fiber length, fiber size, area fineness and fibrillation rate while sizing down the cellulose. According to one aspect, the micronization treatment is preceded by a pretreatment step. For a pretreatment step, it is effective for the starting pulp to be subjected to autoclave treatment or enzyme treatment, or a combination thereof, while impregnated with water at a temperature of 100° C. to 150° C., for conversion to a state that is easily micronized. Such pretreatment has the effect of not only reducing the load in the micronization treatment, but also of causing impurity components such as lignin and hemicellulose, which are present on the surface and in the gaps of the microfibrils forming the cellulose fibers, to be discharged into the aqueous phase, increasing the α-cellulose purity of the micronized fibers as a result, and it is therefore effective for increasing the heat resistance of the microfibrillated cellulose.

For micronization treatment, the starting pulp is dispersed in water and micronized using a publicly known micronization device such as a beater, single disc refiner, double disc refiner or high-pressure homogenizer. The treatment concentration suitable for micronization will differ depending on the device used, and may therefore be set as desired.

The fibrillation rate, area fineness, mean fiber length and mean fiber size of the microfibrillated cellulose can be controlled by the cellulose starting material, the pretreatment conditions prior to micronization treatment (for example, autoclave treatment, enzymatic treatment or beating treatment), the conditions for micronization treatment (selection of the type of device, operating pressure and number of passes), or a combination of the foregoing. The cellulose starting material, pretreatment and micronization can also be controlled by a combination of multiple different conditions.

### Multistage Micronization

When the cellulose is to be micronized in multiple stages, it is effective to combine two or more micronization devices with different micronization mechanisms or shear rates. The method for multistage micronization is preferably multistage micronization using disc refiners with different disc constructions, or micronization with a high-pressure homogenizer after micronization with a disc refiner. The disc refiner used may be either a single disc refiner or double disc refiner.

Multistage Micronization with Multiple Disc Refiners

For micronization in multiple stages using more than one disc refiner, it is preferred to use at least two refiners having different disc constructions. Using refiners with different disc constructions will allow control of the various shape parameters for the microfibrillated cellulose, i.e. the fibrillation rate area fineness, mean fiber length and mean fiber size.

### Disc Refiner Disc Structure

Modifying the disc structure of the disc refiner is an effective means for controlling the shape parameters of the microfibrillated cellulose. The important features of a disc refiner structure are the blade width, groove width and the blade/groove ratio (the blade width divided by the groove width), with the blade/groove ratio being most important for production of fibrillated fibers. If the blade/groove ratio is low the cutting action on the fibers will be larger, thus reducing the fiber lengths, while if the blade/groove ratio is high the action of grinding (beating) the fibers will be greater, thus increasing the fibrillation rate. Since it is important for the composite molded body of the embodiment to include fibrillated fibers, the blade/groove ratio is preferably 0.2 or higher, more preferably 0.4 or higher and most preferably 0.5 or higher. With a constant blade/groove ratio, smaller absolute values for the blade width and groove width will yield fine, homogeneous microfibrillated cellulose.

### Interblade Distance for Disc Refiner Treatment

For micronization with a disc refiner, it is important to control the distance between the two discs (the rotary blade and fixed blade). This distance will hereunder be referred to as the “interblade distance”. Controlling the interblade distance will allow control of the mean fiber length of the microfibrillated cellulose, with a smaller interblade distance resulting in a smaller mean fiber length. For pre-treatment, the interblade distance is preferably 0.05 mm to 2.0 mm, and for post-treatment the interblade distance is preferably 0.05 mm to 1.0 mm. When adjusting the interblade distance, preferably the interblade distance is gradually narrowed from a wide interblade distance to the target interblade distance, as such control will help to prevent clogging or overload of the device, and to yield cellulose fibers with a narrow distribution of fiber length and fiber size and high homogeneity.

### Number of Passes in Disc Refiner Treatment

The degree of micronization can also be controlled by the number of times the cellulose passes through the disc section (hereunder referred to as “number of passes”). By increasing the number of passes it is possible to obtain cellulose fibers having a uniform distribution of fiber size and fiber length. The “number of passes”, for the purpose of the present specification, is the number of times refiner treatment is carried out after the interblade distance has been set to the target value. The number of passes of the disc refiner is preferably 5 times or more, more preferably 20 times or more and even more preferably 40 times or more. A greater number of times is preferred since the distribution of fiber shapes will gradually converge to be constant, but from the standpoint of productivity, the upper limit for the number of passes is 300 times or less.

### Method for Controlling Number of Passes in Disc Refiner Treatment

The method for controlling the number of passes may be a method in which one tank is used for each refiner, and the slurry is circulated alone, controlling the number of passes based on the flow rate, or a method in which two tanks are used for each refiner, and the slurry is reciprocated between tanks while carrying out refiner treatment. The former method allows the equipment to be simplified. In the latter case, the cellulose reliably passes through the disc section during each treatment, allowing microfibrillated cellulose with higher homogeneity to be obtained.

### Multistage Micronization by Combination of Disc Refiner and High-Pressure Homogenizer

Another preferred aspect is micronization treatment of the disc refiner-micronized cellulose fibers, using a high-pressure homogenizer. A high-pressure homogenizer has a greater effect of narrowing fibers than a disc refiner, and its combination with micronization using a disc refiner can yield narrow elongated cellulose fibers.

### Synthetic Pulp

Synthetic pulp can be obtained by a spin draw process on a prepared polymer, a flash prevention method from a solution or emulsion, a strip fiber method by uniaxial stretching of a regulation film, or a shear polymerization method in which a monomer is polymerized under shearing stress. Acrylic pulp may be BiPUL (registered trademark of Japan Exlan Co., Ltd.) and aramid pulp may be Kevlar (registered trademark of DuPont Corp.) or TIARA (registered trademark of Daicel Miraizu, Ltd.). It may also be produced by high-pressure homogenizer treatment, in the same manner as micronized cellulose.

### Staple Fibers

The composite molded body of the disclosure includes staple fibers in addition to fibrillated fibers. As used herein, “staple fibers” means fibers made of a fibrous material and having fiber lengths of 10 mm or less. The staple fibers may be natural fibers, synthetic fibers or semisynthetic fibers. Examples of polymers composing staple fibers include thermoplastic resins such as polyolefins, polyesters, polyamides (aromatic or aliphatic), acrylic polymers, polyvinyl alcohol, polylactic acid, polyphenylene ether, polyoxymethylene and polyphenylene sulfide, and thermosetting resins such as epoxy resins, thermosetting modified polyphenylene ether resins, thermosetting polyimide resins, urea resins, allyl resins, silicon resins, benzoxazine resins, phenol resins, unsaturated polyester resins, bismaleimide-triazine resins, alkyd resins, furan resins, melamine resins, polyurethane resins and aniline resins. Such staple fibers may be used alone or in combinations of more than one. Staple fibers are preferably selected in consideration of properties including heat resistance and chemical resistance, depending on the member in which they are to be applied, and it may be polypropylene, polyamide 6, polyamide 66, polyphenylene ether, polyethylene terephthalate, or combinations thereof. In consideration of moldability of the composite molded body, it preferably includes at least polyethylene terephthalate fibers.

### Mean Fiber Size of Staple Fibers

The mean fiber size of the staple fibers is preferably 0.1 μm to 10.0 μm. If the staple fibers used have a mean fiber size in this range, they will uniformly blend with the fibrillated fibers, producing a composite molded body with a sufficiently micronized interior. By using staple fibers with a fiber size of 10.0 μm or smaller, it will be easier for the staple fibers to vibrate, more easily providing a sound absorption effect. From the viewpoint of preventing localization of the fibrillated fibers and staple fibers inside the composite molded body and preventing excessive denseness of the internal structure of the composite molded body to obtain satisfactory air permeability, the mean fiber size of the staple fibers is more preferably 1.0 μm to 8.0 μm and even more preferably 1.0 μm to 6.0 μm. The fiber size of the staple fibers will usually be expressed as dtex (or T), in which case the mean fiber size may be considered to be a value calculated from the density of the substance composing the fibers.

### Fiber Length of Staple Fibers

The fiber length (also known as “cut length”) of the staple fibers is preferably 5.0 mm or less. Three-dimensional molding will be further facilitated within this range, helping to obtain a homogeneous composite molded body and a more uniform sound absorption effect. The fiber length of the staple fibers is more preferably 4.0 mm or less and even more preferably 3.0 mm or less.

### Fibrillated Fiber Content

The composite molded body preferably includes fibrillated fibers at 0.1 wt % or greater based on the total weight of the composite molded body. Within this range, the fibrillated fibers will be able to further contribute to sound absorption in the low frequency range. By including numerous fibrillated fibers, the strength of the composite molded body is increased and shedding of the fibers from the surface is reduced. The fibrillated fiber content may therefore be adjusted to match the desired sound absorption properties, but from the viewpoint of handleability of the composite molded body and of preventing shedding of the fibers, it is more preferably 5.0 wt % or greater and even more preferably 10.0 wt % or greater. The upper limit is preferably 50 wt % or lower, as this range will provide suitable air permeability without creating an overly dense structure of the composite molded body, and the average sound absorption over all frequencies will be increased. The upper limit is more preferably 40 wt % or lower, even more preferably 30 wt % or lower and most preferably 20 wt % or lower.

### Staple Fiber Content

The composite molded body preferably includes staple fibers at 50 wt % or greater based on the total weight of the composite molded body. A staple fiber content within this range will result in excellent sound absorption properties in the mid to high frequency bands. The staple fiber content is more preferably 60 wt % or greater, even more preferably 70 wt % or greater and most preferably 80 wt % or greater. Since the composite molded body must include fibrillated fibers, the upper limit for the staple fiber content is preferably 99.9 wt % or lower, more preferably 95 wt % or lower and even more preferably 90% or lower.

### Surface Density of Composite Molded Body

The composite molded body has a surface density in the range of 30 g/m² to 1000 g/m². Within this range it will be possible to mold a structure without critical defects, and the structure will be able to function as an air permeability-modifying layer. If the surface density is high the sound absorption property in the low frequency range will be higher, while if it is low the sound absorption property in the mid to high frequency range will be higher, and therefore the surface density is preferably selected in consideration of the frequency of sound to be absorbed. However, from the standpoint of the free-standing property and processability of the composite molded body, and the fact that the air permeability-modifying layer is used primarily for the purpose of absorbing sound in the low to mid frequency range, the surface density is preferably 30 g/m² to 500 g/m², more preferably 50 g/m² to 500 g/m² and even more preferably 100 g/m² to 300 g/m²

### Air Permeability Resistance Per Unit Thickness of Composite Molded Body

The composite molded body has an air permeability resistance per unit thickness of 15.0 s/(100 mL·mm) or lower. The air permeability resistance per unit thickness can be calculated by the following formula.

Air permeability resistance per unit thickness [s/(100 mL·mm)]=Air permeability resistance [s/100 mL]/thickness [mm]

The air permeability resistance (equivalent to the concept of air permeability or flow resistance) and thickness are measured by the following methods. Since the structure of the air permeability-modifying layer is often exceedingly thin, the thickness is often ignored in favor of evaluating the air permeability per unit area. However, without being limited to theory, it is thought that the sound absorption properties of the composite molded body of the disclosure are governed by two different mechanisms: viscosity resistance within the structure and film vibration, which means that limiting the air permeability resistance per unit thickness to a small value is important. Since a large air permeability resistance per unit thickness severely limits incidence of sound waves into the interior of the composite molded body at the uppermost surface layer of the structure, making it impossible to obtain sound absorption by viscosity resistance, it is preferably controlled to within the range specified above. Suitable use as an air permeability-modifying layer is possible within this range, but poor air permeability lowers the sound absorption coefficient in the high frequency range. In light of this, the air permeability resistance per unit thickness is preferably 10.0 s/(100 mL·mm) or lower and more preferably 5.0 s/(100 mL·mm) or lower. Within this range, a high sound absorption coefficient can be obtained in a wide frequency range even with increased thickness of the composite molded body. The lower limit for the air permeability resistance per unit thickness is not particularly restricted but is preferably 0.001 s/(100 mL·mm) or higher, more preferably 0.01 s/(100 mL·mm) or higher and even more preferably 0.1 s/(100 mL·mm) or higher. As mentioned above, the air permeability resistance can be adjusted by the mean fiber length and mean fiber size of the fibrillated fibers, and the mean fiber size of the staple fibers.

### Thickness of Composite Molded Body

The thickness of the composite molded body is preferably 100 μm to 2000 μm. Such a range can provide an excellent sound absorption property with a low volume of sound absorbing material.

The thickness of the composite molded body is more preferably 200 μm to 1500 μm. It should be noted that the thickness cannot be controlled independently but rather, is highly dependent on the surface density. The method for controlling the thickness may be by either of two methods: control based on the material itself or control by processing. A method of controlling the thickness based on the material itself may be control of the fibrillated fiber content, the staple fiber size or the staple fiber type, such as increasing the fibrillated fiber content, thereby lowering the thickness due to closer bond distances between the staple fibers forming the frame.

Control by processing may be reducing the thickness by pressing during molding of the composite molded body. For control of the thickness, such methods may be used alone or as combinations of different methods.

### Bulk Density of Composite Molded Body

The bulk density of the composite molded body is preferably 0.05 g/cm³ to 0.50 g/cm³. If the bulk density is within this range it will be possible to obtain suitable air permeability to facilitate the sound absorption effect. The bulk density is more preferably 0.1 g/cm³ to 0.4 g/cm³ and even more preferably 0.15 g/cm³ to 0.35 g/cm³. The bulk density is calculated by the following formula.

Bulk density [g/cm³]=Surface density [g/m²]/thickness [μm]

Provided that the surface densities of the materials are equal, the bulk density can be controlled by adjusting the material thickness, the material thickness being adjustable by the method described above.

### Three-Dimensional Shaping of Composite Molded Body

The composite molded body can be easily formed into a three-dimensional structure, to form a structure having a homogeneous surface and being free of seams or gaps. The term “three-dimensional structure” as used herein means a structure for the composite molded body that is not two-dimensional (planar or flat), but instead has at least a curved structure (hereunder also referred to as either “three-dimensional” or “spatial structure”).

When a flat air permeability-modifying layer such as a commonly used nonwoven fabric is applied in a three-dimensional structure, the air permeability-modifying layer is disposed on the sound absorbing material surface via cutting, bending and attaching, during which time partial creation of an overlapping structure, or gaps and folds, in the nonwoven fabric become unavoidable. This produces variation in the air permeability, making it impossible to obtain homogeneous sound absorption properties on all surfaces. If the composite molded body is processed three-dimensionally, however, the surface becomes uniform with a structure lacking seams or gaps, so that consistent sound absorption properties can be obtained on all surfaces of the composite molded body, even applied against a sound source with intricate shape, for an excellent overall sound absorption property.

### Method for Producing Composite Molded Body

The method for producing the composite molded body of the disclosure is not particularly restricted, and may be a method that includes dispersing the staple fibers and fibrillated fibers in a liquid medium, and removal and drying of the solvent by filtration and pressing. Mixing the staple fibers and fibrillated fibers in a liquid medium allows a composite molded body with a more homogeneous internal structure to be obtained. A molding method as described above makes processing possible into any desired shape, preferably by a wet papermaking method or pulp molding method. Using a wet papermaking method can yield a two-dimensional flat molded article (i.e. a “nonwoven fabric”), while using a pulp molding method allows shaping into complex three-dimensional shapes. Several different pulp molding methods exist which are suitable depending on the desired molded article. Such methods include the Thick Wall method, in which a molded article having high load resistance is obtained with a very large film thickness of 5 mm to 10 mm, the Transfer Mold method, in which a smooth molded article having a surface with a film thickness of 3 mm to 5 mm is obtained, the Thermoformed Mold method, in which a complex shape with a film thickness of 1 mm to 3 mm is obtained, the PIM (Pulp Injection Mold) method, in which a complex shape is obtained using a boss or rib, as for ordinary plastic molded articles, and the PF (Pulp Forming) method, in which a lightweight, soft molded article is obtained by foaming in a die. Other systems not within this classification may also be employed, so long as they allow three-dimensional shaping. Various additives may also be added to the liquid medium during molding.

### Liquid Medium During Molding

The liquid medium used for molding is not particularly restricted, and a publicly known liquid medium such as water or an organic solvent may be used. While it is preferred to use water in consideration of handleability and low environmental load, a non-polar organic solvent with lower surface tension may be used for the purpose of preventing aggregation when drying and lowering the air permeability resistance per unit thickness. When water is used as the liquid medium, a surfactant may also be added to control the surface tension.

### Molding Additives

By adding a papermaking dispersant or binder and a crosslinking agent as an additive during molding, it is possible to control the handleability, including strength and fiber shedding, as well as the interior uniformity and surface smoothness, of the composite molded body. A papermaking dispersant is a surfactant to facilitate defibration of the bundled staple fibers in a liquid medium or a viscous agent to adjust the viscosity of the liquid medium and prevent aggregation of the fibers, and it allows control of the air permeability resistance per unit thickness by improving the smoothness or homogeneity of the surface and providing uniformity in the internal structure. It should be noted that the added surfactant will also affect the surface tension of the liquid medium. A binder is an adhesive component such as starch, and by adhering together the fibers it allows control of the structural strength and air permeability resistance per unit thickness. A crosslinking agent is an isocyanate or polyurethane, and by chemically or physically crosslinking the intertwined points of the fibers it can prevent shedding of the fibers and adjust their strength. Such additives may be used alone or in combinations of two or more.

### Use of Composite Molded Body

### Sound Absorbing Material

The composite molded body of the disclosure can be suitably used as a sound absorbing material. The composite molded body of the disclosure may be used alone, or several sheets may be layered together for use. When used alone, it exhibits primarily a sound absorbing effect by viscosity resistance, providing sound absorption properties with low sound absorption in the low frequency range and increasing sound absorption coefficient with higher frequencies. For use as a sound absorbing material, the composite molded body of the disclosure preferably has a very high air permeability resistance per unit thickness, to exhibit an effect of sound insulation of certain frequencies.

It may be used as a sound absorbing material in a building, household electrical appliance or automobile, for example. Since the composite molded body of the disclosure can be molded into any desired three-dimensional shape, it can be used not only in flat members but also members with complex three-dimensional shapes, allowing it to be suitably used as a sound absorbing material for automobiles having structural members or devices with complex shapes. Automobile structural members and devices include instrument panels, doors, roofs, floors, tire houses, engines, compressors and motors. By using the composite molded body of the disclosure as a sound absorbing material in such members it is possible to create a silent environment within automobiles, and to reduce noise generated by automobiles. The same applies for the composite sound absorbing material and low frequency reinforced thin sound absorbing material described below.

### Composite Sound Absorbing Material

The composite sound absorbing material of the disclosure has a structure with an air permeability-modifying layer on a support. The air permeability-modifying layer used may be a composite molded body of the disclosure. An air layer may also be provided behind the composite molded body (meaning at a location on the opposite side from the sound source). A sound absorption effect will thus be exhibited by film vibration in addition to viscosity resistance. That is, maximum sound absorption will be exhibited for specific frequencies, while also providing satisfactory sound absorption across the entire range of frequencies. The preferred use is as a sound absorbing material to provide a composite sound absorbing material exhibiting superior sound absorption properties.

### Support

The structure of the support must be an air-permeable structure. For example, a columnar structure may be employed to provide complete gaps behind the air permeability-modifying layer, or a porous material such as felt, a nonwoven fabric or foam may be used to obtain a composite sound absorbing material. When a porous material is used as a support and a composite molded body of the disclosure is layered over it, the composite molded body exhibits its own sound absorption effect while also acting as an air permeability-modifying layer. It is undesirable to use a structure without air permeability, such as a resin sheet lacking a foam structure, as the support.

### Porous Material

Using a porous material as the support is preferred to allow regulation of the sound absorption properties. Using a material with high air permeability as the porous material can provide an excellent sound absorption effect across a wide range of frequencies, while using a material with poor air permeability can provide a particularly excellent sound absorption effect for specific frequencies. The porous material preferably has higher air permeability than the composite molded body. The index for air permeability may be the air permeability resistance per unit thickness, explained above. Examples of porous materials include, but are not limited to, publicly known porous materials such as nonwoven fabrics, felt and foam.

### Support Thickness

The support preferably has a thickness of 5 mm or greater. The thickness of the support is the thickness of the structure with air permeability and does not include the thickness of the structure without air permeability. When a sound absorption effect is obtained by the effect of film vibration, the exhibited frequency characteristic changes considerably depending on the thickness of the underlying air layer. Specifically, a small air layer thickness produces an excellent sound absorption property in the high frequency range, while a large air layer thickness produces an excellent sound absorption effect in the low frequency range. The support thickness is therefore preferably 6 mm or greater and most preferably 7 mm or greater. The upper limit is not particularly restricted, but from the viewpoint of reducing space requirements for the sound absorbing material, it is preferably 50 mm or smaller, more preferably 30 mm or smaller, even more preferably 10 mm or smaller and most preferably 8 mm or smaller.

### Method of Layering on Support

The composite molded body of the disclosure may be layered with the support by any of a variety of different means. Examples include a method of heating only the surface of the composite molded body with an IR heater, for joining by heat fusion, and a method of coating the composite molded body surface with a hot-melt adhesive using a curtain spray system, and then heating for heat fusion.

### Thickness of Air Permeability-Modifying Layer in Composite Sound Absorbing Material

When a porous body is used as the support, it is possible to control the thickness of the air permeability-modifying layer in the composite sound absorbing material by changing the number of layers of the composite molded body or by changing the thickness per layer of the composite molded body (the composite molded body thickness described above), thereby allowing the sound absorption properties to be adjusted. Increasing the thickness of the air permeability-modifying layer lowers the air permeability of the structure as a whole, exhibiting a higher sound absorption effect for the low frequency range. Lower air permeability also tends to reduce the sound absorption effect for the high frequency range. The thickness of the air permeability-modifying layer is not particularly restricted, and may be adjusted to match a sound source whose sound is to be absorbed for satisfactory control of the frequency characteristic.

### Method of Controlling Air Permeability-Modifying Layer Thickness

When comparing a method of controlling the thickness of the air permeability-modifying layer by changing the number of layers against a method of controlling the thickness of the air permeability-modifying layer by controlling the thickness of each layer of the composite molded body, the frequency dependence for sound absorption is lower in the former case (i.e. the maximum sound absorption coefficient is reduced and the average sound absorption across the entire frequency range is higher). In the latter case, however, frequency dependence is increased (i.e. the maximum sound absorption coefficient is increased and average sound absorption across the entire frequency range is lower), while a high sound absorption effect is also obtained at lower frequencies. The thickness of the air permeability-modifying layer and the method for controlling it may be adjusted according to the sound source whose sound is to be absorbed, or it may be used according to the purpose, to satisfactorily control the sound absorption properties.

### Low Frequency Reinforced Thin Composite Sound Absorbing Material

By adjusting the thickness of the air permeability-modifying layer and adjusting the surface density of the air permeability-modifying layer, it is possible to obtain a composite sound absorbing material exhibiting excellent sound absorption in the low to mid frequency range with an extremely thin structure, and exhibiting sound absorption in a wide frequency range of 500 Hz to 6400 Hz (this will hereunder be referred to as “low frequency reinforced thin composite sound absorbing material”). Specifically, the low frequency reinforced thin composite sound absorbing material preferably has an overall structural thickness of 10 mm or smaller and a structure in which an air permeability-modifying layer and a porous material are layered, wherein:
(a) the surface density of the air permeability-modifying layer is 100 g/m² to 1000 g/m²,
(b) the air permeability resistance of the air permeability-modifying layer is 0.1 s/100 mL to 2.0 s/100 mL,
(c) the thickness of the air permeability-modifying layer is 0.50 mm to 5.00 mm, and
(d) the thickness of the porous material is 5.00 mm or greater.

By satisfying all of the conditions (a) to (d), it is possible to obtain a low frequency reinforced thin composite sound absorbing material having all of the following sound absorption properties based on measurement of normal incidence according to JIS A 1405:
(1) having a maximum for sound absorption at 3000 Hz or lower,
(2) having a sound absorption coefficient of 0.3 or greater at 1000 Hz,
(3) having an average sound absorption of 0.4 or greater for 800 to 2000 Hz, and
(4) having an average sound absorption of 0.3 or greater for 500 to 6400 Hz. Absorption of low frequencies and high frequencies of sound by a composite sound absorbing material obtained by modifying air permeation on the surface, is generally in a trade-off relationship, and absorption of both can only be achieved by increasing the thickness of the structure as a whole. However, the low frequency reinforced thin composite sound absorbing material of the disclosure can at least partially eliminate this trade-off while maintaining a small thickness. The factors collectively contributing to this result are thought to be that the thickness of the air permeability-modifying layer is extremely large for an air permeability-modifying layer, and that the air permeability-modifying layer itself has a sound absorption effect due to film vibration. When a composite molded body of the disclosure is used as an air permeability-modifying layer, the fibers with very fine fiber sizes (fibrillated fibers) and the relatively thicker staple fibers exhibit a sound absorption effect in different frequency ranges due to viscosity resistance, thus further eliminating the trade-off relationship.

### Sound Absorption Properties of Low Frequency Reinforced Thin Composite Sound Absorbing Material

The low frequency reinforced thin composite sound absorbing material of the disclosure has excellent sound absorption properties in the low to mid frequency range despite the thin structure as mentioned above, while also exhibiting a sound absorption effect across a wide frequency range of 500 Hz to 6400 Hz. The sound absorption coefficient at 1000 Hz is preferably 0.4 or greater and more preferably 0.5 or greater. The average sound absorption at 800 Hz to 2000 Hz is preferably 0.5 or greater and more preferably 0.6 or greater. The average sound absorption at 500 Hz to 6400 Hz is preferably 0.4 or greater and more preferably 0.5 or greater.

### Structure of Air Permeability-Modifying Layer in Low Frequency Reinforced Thin Composite Sound Absorbing Material

In order to obtain such desirable sound absorption properties it is sufficient to control the structure of the air permeability-modifying layer, i.e. the surface density, air permeability resistance and thickness of the air permeability-modifying layer. When multiple composite molded bodies are layered, the surface density, air permeability resistance and thickness of the air permeability-modifying layer are the total values, i.e. the values measured when they are layered. The effects of controlling the values are the same effects obtained when controlling the surface density, air permeability resistance per unit thickness and thickness of the composite molded body, as described above. The surface density is preferably 150 g/m² to 300 g/m², the air permeability resistance is preferably 0.5 s/100 mL to 1.5 s/100 mL and more preferably 1.0 s/100 mL to 1.5 s/100 mL, and the air permeability-modifying layer thickness is preferably 0.75 mm to 2.00 μm and more preferably 0.75 mm to 2.00 μm. The thickness of the porous material support may be arbitrarily adjusted depending on the air permeability-modifying layer.

### Thickness of Low Frequency Reinforced Thin Composite Sound Absorbing Material

The low frequency reinforced thin composite sound absorbing material has a thickness of 10 mm or smaller for the overall structure. The sound absorption properties can also be controlled by controlling the thickness of the overall structure, similar to a common sound absorbing material. Since a structure with a large thickness is effective for sound absorption of low frequencies, the overall structure preferably has a larger thickness, the lower limit for the thickness being preferably 5.5 mm or greater, more preferably 7.0 mm or greater, even more preferably 8.0 mm or greater and most preferably 9.0 mm or greater.

### EXAMPLES

Embodiments of the disclosure will now be explained in detail by Examples and Comparative Examples, with the understanding that the Examples are not limitative on the disclosure.

### Measurement and Evaluation Methods

### Mean Fiber Size (Method a and Method B), Fibrillation Rate and Area Fineness of Fibrillated Fibers

The mean fiber size (Method A), fibrillation rate and area fineness of the fibrillated fibers were measured by the following procedures using an automatic fiber shape analyzer (MorFi Neo by Technidyne). The threshold values for the minimum fiber length and maximum fiber length during measurement were 100 μm and 1500 μm, respectively.
(1) Fibrillated fibers were dispersed in purified water to prepare a 1 L aqueous dispersion. The final solid concentration of the fibrillated fibers was 0.003 wt % to 0.005 wt %. For an aqueous dispersion of fibrillated fibers at 2 wt % or lower, dispersion treatment was carried out by simple mixing with a spatula. For an aqueous dispersion, or a wet cake or powder at 2 wt % or greater, a high-shear homogenizer (trade name: “ULTRA-TURRAX T18” by IKA Co.) was used for dispersion treatment with treatment conditions of 25,000 rpm×5 min.
(2) The aqueous dispersion prepared in (1) was supplied to an autosampler for measurement.
(3) The measurement results for the mean fiber width (μm), macro fibrillation index (%) and fine content, in area (%) were read off as the mean fiber size (Method A), fibrillation rate and area fineness, respectively.

The mean fiber size of the fibrillated fibers (Method B) was measured by the following procedure using a specific surface area/pore distribution analyzer (NOVA-4200e by Quantachrome Instruments). Fibrillated fibers that aggregated by drying as fibrillated cellulose fine fibers were measured after the following pretreatment.

### [Pretreatment]

(1) The fibrillated fine fiber aqueous dispersion was filtered to prepare a wet cake.
(2) The obtained wet cake was added to tert-butanol and diluted with tert-butanol to a fibrillated fiber solid concentration of 0.5 wt %, and a high-shear homogenizer (trade name: “ULTRA-TURRAX T18” by IKA Co.) was used for dispersion treatment with treatment conditions of 25,000 rpm×5 min.
(3) The obtained dispersion was weighed out to a basis weight of 10 g/m³ and filtered with filter paper to obtain a sheet.
(4) Without being released from the filter paper, the obtained sheet together with the filter paper was sandwiched by two larger filter paper sheets, and dried for 5 minutes in an oven at 150° C. while pressing the edges of the filter paper with a weight from above, to obtain a porous sheet.

### [Measurement of Specific Surface Area and Calculation of Fiber Size]

(1) The fibrillated fibers (porous sheet fabricated by pretreatment) in an amount of 0.2 g by solid content were dried in a vacuum at 120° C. for 5 minutes.
(2) After drying, the adsorption of nitrogen gas at the boiling point of liquid nitrogen was measured at 5 points with a relative vapor pressure (P/P₀) in the range of 0.05 to 0.2 (multipoint method), after which the BET specific surface area (m²/g) was calculated by the program provided by the apparatus.
(3) The average specific surface area was calculated from the BET specific surface area value Y (m²/g) by the following formula, using the mean fiber length X (nm) and the density ρ (g/cm³) of the fibrillated fibers.

$$Mean fiber size ( nm ) = 1 / ( 2.5 \times ρ \times Y \times {10}^{- 4} )$$

### Air Permeability Resistance of Composite Molded Body

The air permeability resistance of the composite molded body is the result of measuring the permeation time for 100 mL of air using a Gurley densometer (for example, a model G-B2C by Toyo Seiki Co., Ltd.), and it was measured by the following procedure.
(1) A 5 cm×5 cm size section was obtained from 5 different points of the composite molded body. (When the dimensions of the composite molded body were too small, 5 sections were obtained from different composite molded bodies.)
(2) The air permeability resistance of each section was measured at 5 points using a Gurley densometer (model G-B2C by Toyo Seiki Co., Ltd.).
(3) The average value for the 5 points obtained in procedure (2) was recorded as the air permeability resistance of the composite molded body.

### Thickness of Composite Molded Body

The thickness of the composite molded body was measured by the following procedure.
(1) A 5 cm×5 cm size section was obtained from 5 different points of the composite molded body. (When the dimensions of the composite molded body were too small, 5 sections were obtained from different composite molded bodies.)
(2) The thickness of each section was measured using an ABS Digimatic Indicator ID-CX (Mitsutoyo Corp.). The probe used was a φ15 mm flat probe.
(3) The average value for the 5 points obtained in procedure (2) was recorded as the thickness of the composite molded body.

### Air Permeability Resistance Per Unit Thickness and Bulk Density of Composite Molded Body

The air permeability resistance and thickness of the composite molded body were calculated from the surface density, based on the following definition.

$$Air permeability resistance per unit thickness = Air permeability resistance [ s / 100 mL ] / thickness [ mm ]$$

$$Bulk density = Surface density [ g / {m}^{2} ] / thickness [ mm ]$$

### Free-Standing Property and Fiber Shedding Property of Composite Molded Body

The free-standing property and fiber shedding of the composite molded body were evaluated based on the following definitions.

### [Free-Standing Property of Composite Molded Body]

A: No bending or breaking when handled with one hand
B: Easily bent or broken when handled with one hand

### [Fiber Shedding]

A: No adhesion of shed fibers from the surface when touched with the bare hand
B: Adhesion of shed fibers from the surface when touched with the bare hand

### Evaluation of Sound Absorption Properties of Composite Sound Absorbing Material

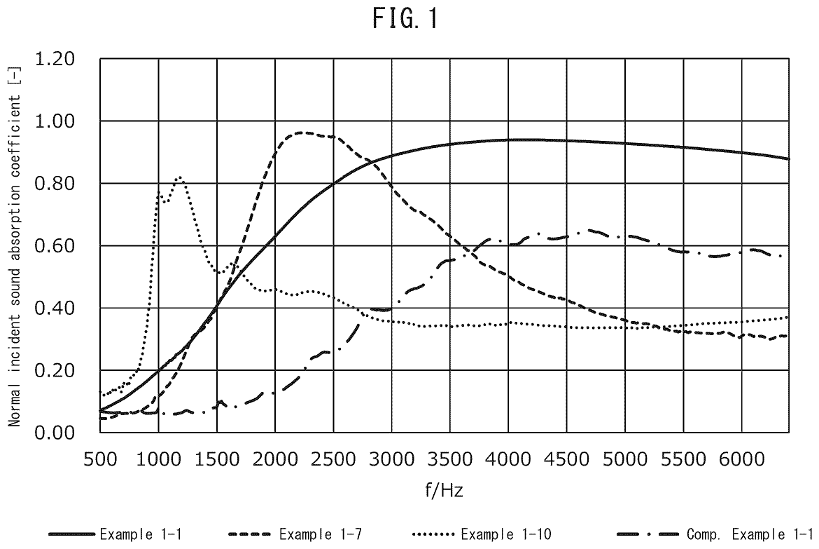

A circular disc with a diameter of 28.8 mm was cut out from each of the composite molded bodies of the Examples and Comparative Examples, and naturally layered against coarse felt with a thickness of 8.0 mm to form a composite sound absorbing material. The sound absorption coefficient of the composite sound absorbing material was measured according to JIS A 1405, using a DS-2000 normal incident sound absorption coefficient measuring system (Ono Sokki Co., Ltd.). The measurement was conducted with the composite molded body on the sound wave incident side. Some of the measurement results are shown in FIG. 1.

### Evaluation of Sound Absorption Properties of Composite Molded Body Alone

A circular disc with a diameter of 28.8 mm was cut out from each composite molded body of the Examples, and the sound absorption coefficient was measured according to JIS A 1405 using a DS-2000 normal incident sound absorption coefficient measuring system (Ono Sokki Co., Ltd.), with a 10.0 mm air layer provided underneath.

### Evaluation of Sound Absorption Properties of Low Frequency Reinforced Thin Composite Sound Absorbing Material

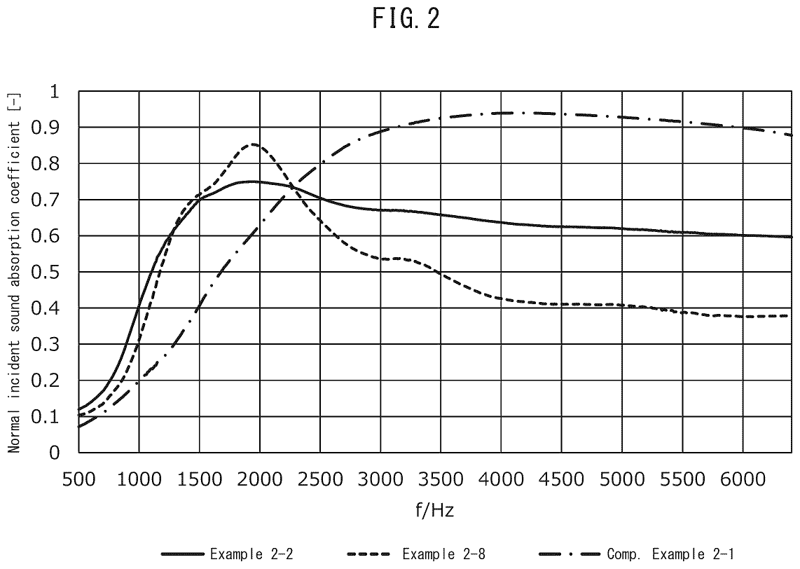

A predetermined number of circular discs each with a diameter of 28.8 mm were cut out from each of the composite molded bodies of the Examples and Comparative Examples, and all were naturally layered against coarse felt with a thickness of 8.0 mm to form a low frequency reinforced thin composite sound absorbing material. The sound absorption coefficient of the composite sound absorbing material was measured according to JIS A 1405, using a DS-2000 normal incident sound absorption coefficient measuring system (Ono Sokki Co., Ltd.). The measurement was conducted with the composite molded body on the sound wave incident side. Some of the measurement results are shown in FIG. 2.

### Evaluation of Sound Absorption Properties of Three-Dimensional Composite Sound Absorbing Material

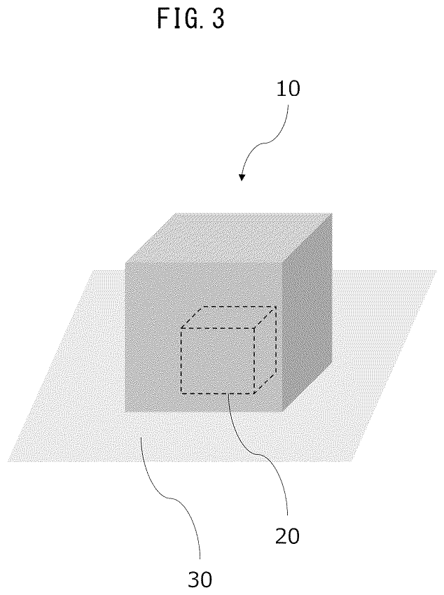

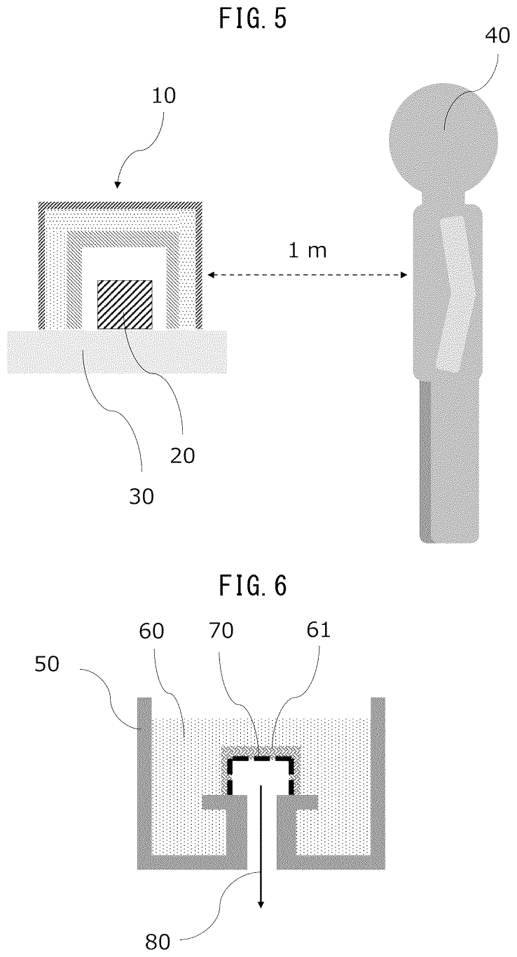

FIGS. 3 to 5 are schematic diagrams showing the structure of a three-dimensional composite sound absorbing material, and a schematic diagram illustrating the evaluation method. Felt (12) with a thickness of 8 mm and PP sheets (11, thickness: 1 mm) were attached to the outer sides of each of the composite molded bodies of the Examples and Comparative Examples using double-sided tape and a rapid bonding adhesive, to prepare a three-dimensional composite sound absorbing material (10). The three-dimensional composite sound absorbing material (10) was disposed covering a sound source (20) placed on a desk (30). The sound source used was a Bluetooth™ speaker. The speaker was connected to a smartphone, and an application (Tuning Fork Pro) was used to output 1045.7 Hz, 1478.9 Hz and 1974.1 Hz tones. The sound pressure at all frequencies was set to be 70 dB without the sound absorbing material. The ambient sound level was 48 dB. During this period, an evaluator (40) standing at a distance of 1.0 μm from the side wall of the three-dimensional composite sound absorbing material (10) was asked to confirm the degree to which the sound level decreased (the percentage of the original sound level), and the average value for evaluations by 10 evaluators was used as the evaluation result for the sound absorption property.

### Fibrillated Fibers

### Fibrillated Fibers A

Fibrillated fibers of polyacrylonitrile (BiPUL, product of Japan Exlan Co., Ltd., 18% solid weight) were used as fibrillated fibers A. The results of evaluating the fibrillation rate, area fineness, mean fiber length and mean fiber size are shown in Table 1.

### Fibrillated Fibers B

Tencel cut filaments (3 mm lengths), as regenerated (type II) cellulose fibers acquired from Sojitz Corp., were placed in a washing net, a surfactant was added, and the mixture was washed with water several times in a washing machine to remove the oil agent on the fiber surfaces.

A Labo Pulper (Aikawa Iron Works Co.) was used for simple dispersion, followed by delivery to a tank. The slurry was micronized while circulating with a single disc refiner (first stage) equipped with a disc having a 2.5 mm blade width and a 7.0 mm groove width, connected to the tank. The operation was completed when the total slurry amount had passed through the disc section 35 times, with an interblade distance of 1.0 mm. The slurry was then micronized while circulating with a single disc refiner (second stage) equipped with a disc having a 0.8 mm blade width and a 1.5 mm groove width. Operation was initiated with an interblade distance of 1.0 mm, gradually narrowing the interblade distance to a final interblade distance of 0.35 mm. After the interblade distance reached 0.35 mm, operation was continued while confirming the flow rate, and operation was stopped when the total amount of slurry had passed through the disc section 120 times. The obtained microfibrillated cellulose was used as fibrillated fibers B. The results of evaluating the fibrillation rate, area fineness, mean fiber length and mean fiber size are shown in Table 1.

### Fibrillated Fibers C

Fibrillated fibers B were subjected to further micronization treatment using a high-pressure homogenizer (NS015H by Niro Soavi). The slurry was treated in a batch style with five treatments. The results of evaluating the fibrillation rate, area fineness, mean fiber length and mean fiber size are shown in Table 1.

### Fibrillated Fibers D

Linter pulp, as natural cellulose acquired from Japan Pulp and Paper Co., was immersed in water to 1.5 wt %, and a Labo Pulper (Aikawa Iron Works Co.) was used for simple dispersion, followed by delivery to a tank. The slurry was micronized while circulating with a single disc refiner (first stage) equipped with a disc having a 2.5 mm blade width and a 7.0 mm groove width, connected to the tank. Operation was initiated with an interblade distance of 1.0 mm, gradually narrowing the interblade distance to a final interblade distance of 0.05 mm. After the interblade distance reached 0.05 mm, operation was continued while confirming the flow rate, and operation was stopped when the total amount of slurry had passed through the disc section 10 times. The slurry was then micronized while circulating with a single disc refiner (second stage) equipped with a disc having a 0.6 mm blade width and a 1.0 mm groove width. Operation was initiated with an interblade distance of 1.0 mm, gradually narrowing the interblade distance to a final interblade distance of 0.05 mm. After the interblade distance reached 0.05 mm, operation was continued while confirming the flow rate, and operation was stopped when the total amount of slurry had passed through the disc section 180 times. The obtained microfibrillated cellulose was used as fibrillated fibers D. The results of evaluating the fibrillation rate, area fineness, mean fiber length and mean fiber size are shown in Table 1.

### Production Examples for Composite Molded Body

### Example 1-1

Fibrillated fibers A and PET staple fibers A (TA04PN by Teijin, Ltd., fineness: 0.1 T, mean fiber size: 3.0 μm, cut length: 3 mm) were used to fabricate a composite molded body by the following procedure.

The fibrillated fibers and staple fibers were added to purified water in a solid weight ratio of 20:80 to a final solid concentration of 0.5%, and the mixture was stirred with a household mixer for 4 minutes to prepare a slurry.

The prepared slurry was loaded into in a batch paper machine (automatic square sheet machine by Kumagai Riki Kogyo Co., Ltd., 25 cm×25 cm, 80 mesh) in which a filter cloth (TT35 by Shikishima Canvas Co., Ltd.) was set, to a surface density of 50 g/m², after which paper-making (dewatering) was carried out with pressure reduction of 50 KPa relative to atmospheric pressure.

The aforementioned filter cloth was used to cover the surface of the wet concentrated composition on a filter cloth, and was detached from the wire and pressed for 1 minute at a pressure of 1 kg/cm². It was then dried for about 120 seconds in a drum dryer set to a surface temperature of 130° C., to obtain a composite molded body S1. A circular disc with a diameter of 28.8 mm was cut out from the obtained composite molded body, and naturally layered against coarse felt with a thickness of 8.0 mm to form a composite sound absorbing material. The physical properties of the obtained composite molded body, and the sound absorption properties of the composite sound absorbing material, are shown in Table 1.

### Example 1-2

Composite molded body S2 was obtained by the same method as Example 1, except that PET fibers B (TA04N by Teijin, Ltd., fineness: 0.5 T, mean fiber size: 7.0 μm, cut length: 5 mm) were used as the staple fibers. A circular disc with a diameter of 28.8 mm was cut out from the obtained composite molded body, and naturally layered against coarse felt with a thickness of 8.0 mm to form a composite sound absorbing material. The physical properties of the obtained composite molded body, and the sound absorption properties of the composite sound absorbing material, are shown in Table 1.

### Example 1-3

Composite molded body S3 was obtained by the same method as Example 1, except that the surface density was 100 g/m². A circular disc with a diameter of 28.8 mm was cut out from the obtained composite molded body, and naturally layered against coarse felt with a thickness of 8.0 mm to form a composite sound absorbing material. The physical properties of the obtained composite molded body, and the sound absorption properties of the composite sound absorbing material, are shown in Table 1.

### Example 1-4

Composite molded body S4 was obtained by the same method as Example 1, except that the solid weight ratio of the fibrillated fibers and staple fibers was 30:70. A circular disc with a diameter of 28.8 mm was cut out from the obtained composite molded body, and naturally layered against coarse felt with a thickness of 8.0 mm to form a composite sound absorbing material. The physical properties of the obtained composite molded body, and the sound absorption properties of the composite sound absorbing material, are shown in Table 1.

### Example 1-5

Composite molded body S5 was obtained by the same method as Example 1, except that the surface density was 150 g/m² and the solid weight ratio of the fibrillated fibers and staple fibers was 10:90. A circular disc with a diameter of 28.8 mm was cut out from the obtained composite molded body, and naturally layered against coarse felt with a thickness of 8.0 mm to form a composite sound absorbing material. The physical properties of the obtained composite molded body, and the sound absorption properties of the composite sound absorbing material, are shown in Table 1.

### Example 1-6

Composite molded body S6 was obtained by the same method as Example 1, except that fibrillated fibers B were used as the fibrillated fibers, and PET staple fibers C (TA04PN by Teijin, Ltd., fineness: 0.3 T, mean fiber size: 5.3 μm, cut length: 3 mm) were used as the staple fibers. A circular disc with a diameter of 28.8 mm was cut out from the obtained composite molded body, and naturally layered against coarse felt with a thickness of 8.0 mm to form a composite sound absorbing material. The physical properties of the obtained composite molded body, and the sound absorption properties of the composite sound absorbing material, are shown in Table 1.

### Example 1-7

Composite molded body S7 was obtained by the same method as Example 1, except that fibrillated fibers C were used as the fibrillated fibers and the surface density was 100 g/m². A circular disc with a diameter of 28.8 mm was cut out from the obtained composite molded body, and naturally layered against coarse felt with a thickness of 8.0 mm to form a composite sound absorbing material. The physical properties of the obtained composite molded body, and the sound absorption properties of the composite sound absorbing material, are shown in Table 1.

### Example 1-8

Composite molded body S8 was obtained by the same method as Example 1, except that fibrillated fibers B were used as the fibrillated fibers, the surface density was 100 g/m², and the solid weight ratio of the fibrillated fibers and staple fibers was 5:95. A circular disc with a diameter of 28.8 mm was cut out from the obtained composite molded body, and naturally layered against coarse felt with a thickness of 8.0 mm to form a composite sound absorbing material. The physical properties of the obtained composite molded body, and the sound absorption properties of the composite sound absorbing material, are shown in Table 2.

### Example 1-9

Composite molded body S9 was obtained by the same method as Example 1, except that fibrillated fibers B were used as the fibrillated fibers, the surface density was 300 g/m², and the solid weight ratio of the fibrillated fibers and staple fibers was 5:95. A circular disc with a diameter of 28.8 mm was cut out from the obtained composite molded body, and naturally layered against coarse felt with a thickness of 8.0 mm to form a composite sound absorbing material. The physical properties of the obtained composite molded body, and the sound absorption properties of the composite sound absorbing material, are shown in Table 2.

### Example 1-10

Composite molded body S10 was obtained by the same method as Example 1, except that fibrillated fibers B were used as the fibrillated fibers, PP fibers (AIRYMO by Ube Exsymo Inc., fineness: 0.2 T, mean fiber size: 5.3 μm, cut length: 2 mm) were used as the staple fibers, the surface density was 300 g/m² and the solid weight ratio of the fibrillated fibers and staple fibers was 5:95. A circular disc with a diameter of 28.8 mm was cut out from the obtained composite molded body, and naturally layered against coarse felt with a thickness of 8.0 mm to form a composite sound absorbing material. The physical properties of the obtained composite molded body, and the sound absorption properties of the composite sound absorbing material, are shown in Table 2.

### Example 1-11

Composite molded body S11 was obtained by the same method as Example 1, except that fibrillated fibers B were used as the fibrillated fibers, and the solid weight ratio of the fibrillated fibers and staple fibers was 30:70. A circular disc with a diameter of 28.8 mm was cut out from the obtained composite molded body, and naturally layered against coarse felt with a thickness of 8.0 mm to form a composite sound absorbing material. The physical properties of the obtained composite molded body, and the sound absorption properties of the composite sound absorbing material, are shown in Table 2.

### Example 1-12

The sound absorption properties of composite molded body S1 fabricated in Example 1 were evaluated independently. As a result of evaluating the sound absorption properties, the peak frequency was 3990 Hz, the sound absorption coefficient at peak frequency was 0.91, and the average sound absorption at 500 Hz to 6400 Hz was 0.73.

### Comparative Example 1-1

Composite molded body R-1 was obtained by the same method as Example 1, except that fibrillated fibers B were used as the fibrillated fibers and the surface density was 25 g/m². A circular disc with a diameter of 28.8 mm was cut out from the obtained composite molded body, and naturally layered against coarse felt with a thickness of 8.0 mm to form a composite sound absorbing material. The physical properties of the obtained composite molded body, and the sound absorption properties of the composite sound absorbing material, are shown in Table 1.

### Comparative Example 1-2

Composite molded body R-2 was obtained by the same method as Example 1, except that fibrillated fibers D were used as the fibrillated fibers and the surface density was 100 g/m². A circular disc with a diameter of 28.8 mm was cut out from the obtained composite molded body, and naturally layered against coarse felt with a thickness of 8.0 mm to form a composite sound absorbing material. The physical properties of the obtained composite molded body, and the sound absorption properties of the composite sound absorbing material, are shown in Table 1.

### Comparative Example 1-3

Composite molded body R-3 was obtained by the same method as Example 1, except that fibrillated fibers B were used as the fibrillated fibers, the surface density was 100 g/m², and the solid weight ratio of the fibrillated fibers and staple fibers was 50:50. A circular disc with a diameter of 28.8 mm was cut out from the obtained composite molded body, and naturally layered against coarse felt with a thickness of 8.0 mm to form a composite sound absorbing material. The physical properties of the obtained composite molded body, and the sound absorption properties of the composite sound absorbing material, are shown in Table 1.

### Production Examples for Composite Sound Absorbing Material

### Example 2-1

Three circular discs each with a diameter of 28.8 mm were cut out from composite molded body S1, and all were naturally layered against coarse felt with a thickness of 8.0 mm to form a low frequency reinforced thin composite sound absorbing material. The sound absorption properties of the obtained composite sound absorbing material are shown in Table 3.

### Example 2-2

Four circular discs each with a diameter of 28.8 mm were cut out from composite molded body S1, and all were naturally layered against coarse felt with a thickness of 8.0 mm to form a low frequency reinforced thin composite sound absorbing material. The sound absorption properties of the obtained composite sound absorbing material are shown in Table 3.

### Example 2-3

Two circular discs each with a diameter of 28.8 mm were cut out from composite molded body S2, and both were naturally layered against coarse felt with a thickness of 8.0 mm to form a low frequency reinforced thin composite sound absorbing material. The sound absorption properties of the obtained composite sound absorbing material are shown in Table 3.

### Example 2-4

Three circular discs each with a diameter of 28.8 mm were cut out from composite molded body S2, and all were naturally layered against coarse felt with a thickness of 8.0 mm to form a low frequency reinforced thin composite sound absorbing material. The sound absorption properties of the obtained composite sound absorbing material are shown in Table 3.

### Example 2-5

Two circular discs each with a diameter of 28.8 mm were cut out from composite molded body S3, and both were naturally layered against coarse felt with a thickness of 8.0 mm to form a low frequency reinforced thin composite sound absorbing material. The sound absorption properties of the obtained composite sound absorbing material are shown in Table 3.

### Example 2-6

Three circular discs each with a diameter of 28.8 mm were cut out from composite molded body S3, and all were naturally layered against coarse felt with a thickness of 8.0 mm to form a low frequency reinforced thin composite sound absorbing material. The sound absorption properties of the obtained composite sound absorbing material are shown in Table 3.

### Example 2-7

One circular disc with a diameter of 28.8 mm was cut out from composite molded body S5, and naturally layered against coarse felt with a thickness of 8.0 mm to form a low frequency reinforced thin composite sound absorbing material (the same composite sound absorbing material as Example 1-5). The sound absorption properties of the obtained composite sound absorbing material are shown in Table 3.

### Example 2-8

Three circular discs each with a diameter of 28.8 mm were cut out from composite molded body S6, and all were naturally layered against coarse felt with a thickness of 8.0 mm to form a low frequency reinforced thin composite sound absorbing material. The sound absorption properties of the obtained composite sound absorbing material are shown in Table 3.

### Example 2-9

Two circular discs each with a diameter of 28.8 mm were cut out from composite molded body S8, and both were naturally layered against coarse felt with a thickness of 8.0 mm to form a low frequency reinforced thin composite sound absorbing material. The physical properties of the obtained composite molded body, and the sound absorption properties of the composite sound absorbing material, are shown in Table 4.

### Example 2-10

Three circular discs each with a diameter of 28.8 mm were cut out from composite molded body S8, and all were naturally layered against coarse felt with a thickness of 8.0 mm to form a low frequency reinforced thin composite sound absorbing material. The sound absorption properties of the obtained composite sound absorbing material are shown in Table 4.

### Example 2-11

One circular disc with a diameter of 28.8 mm was cut out from composite molded body S9, and naturally layered against coarse felt with a thickness of 8.0 mm to form a low frequency reinforced thin composite sound absorbing material (the same composite sound absorbing material as Example 1-9). The sound absorption properties of the obtained composite sound absorbing material are shown in Table 4.

### Example 2-12

One circular disc with a diameter of 28.8 mm was cut out from composite molded body S10, and naturally layered against coarse felt with a thickness of 8.0 mm to form a low frequency reinforced thin composite sound absorbing material (the same composite sound absorbing material as Example 1-10). The sound absorption properties of the obtained composite sound absorbing material are shown in Table 4.

### Example 2-13

One circular disc with a diameter of 28.8 mm was cut out from composite molded body S1, and naturally layered against coarse felt with a thickness of 8.0 mm to form a composite sound absorbing material (the same composite sound absorbing material as Example 1-1). The sound absorption properties of the obtained composite sound absorbing material are shown in Table 4.

### Example 2-14

Two circular discs each with a diameter of 28.8 mm were cut out from composite molded body S1, and both were naturally layered against coarse felt with a thickness of 8.0 mm to form a composite sound absorbing material. The sound absorption properties of the obtained composite sound absorbing material are shown in Table 4.

### Example 2-15

Six circular discs each with a diameter of 28.8 mm were cut out from composite molded body S6, and all were naturally layered against coarse felt with a thickness of 8.0 mm to form a composite sound absorbing material. The sound absorption properties of the obtained composite sound absorbing material are shown in Table 4.

### Example 2-1

Six circular discs each with a diameter of 28.8 mm were cut out from composite molded body S8, and all were naturally layered against coarse felt with a thickness of 8.0 mm to form a composite sound absorbing material. The sound absorption properties of the obtained composite sound absorbing material are shown in Table 4.

### Comparative Example 2-1

One circular disc with a diameter of 28.8 mm was cut out from composite molded body R1, and naturally layered against coarse felt with a thickness of 8.0 mm to form a composite sound absorbing material. The sound absorption properties of the obtained composite sound absorbing material are shown in Table 4.

### Comparative Example 2-2

One circular disc with a diameter of 28.8 mm was cut out from composite molded body R2, and naturally layered against coarse felt with a thickness of 8.0 mm to form a composite sound absorbing material. The sound absorption properties of the obtained composite sound absorbing material are shown in Table 4.

### Comparative Example 2-3

One circular disc with a diameter of 28.8 mm was cut out from composite molded body R3, and naturally layered against coarse felt with a thickness of 8.0 mm to form a composite sound absorbing material. The sound absorption properties of the obtained composite sound absorbing material are shown in Table 4.

### Production Examples for Composite Sound Absorbing Material by Pulp Molding Method

### Example 3-1

Fibrillated fibers A and PET staple fibers A (TA04PN by Teijin, Ltd., fineness: 0.1 T, mean fiber size: 3.0 μm, cut length: 3 mm) were used to fabricate a composite molded body by the following procedure.

The fibrillated fibers and staple fibers were added to purified water in a solid weight ratio of 10:90 to a final solid concentration of 0.5%, and the mixture was stirred with a household mixer for 4 minutes to prepare a slurry.

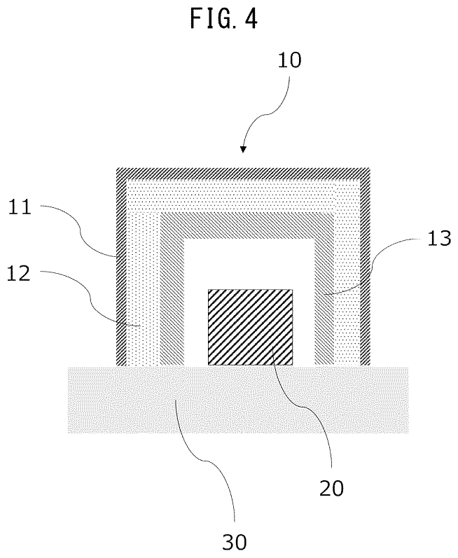

The slurry (60) was placed in a material tank (50), as shown schematically in FIG. 6. The pressure in the depressurization direction (80) was reduced for adsorption on the surface of a metal mesh (70) in the form of a basket (a cuboid shape open on one side) to a surface density of 150 g/m², to obtain a concentrated slurry (60). The obtained concentrated slurry (60) was pressed into a die and dewatered, and then dried for 10 minutes in an oven heated to 130° C. The resulting three-dimensional composite molded body had a structure with a uniform surface free of folds, seams or cut lines. Felt (12) with a thickness of 8 mm and PP sheets (11, thickness: 1 mm) were attached to the outer sides using double-sided tape and a rapid bonding adhesive, as shown schematically in FIGS. 3 and 4, to prepare a three-dimensional composite sound absorbing material (10). The results of evaluating the physical properties and sound absorption properties of the composite molded body are shown in Table 5.

### Example 3-2

A flat composite molded body S5 was attached to felt with a thickness of 8.0 mm using an adhesive, and then cellophane tape and an adhesive were used for assembly into a basket shape. Partial gaps were confirmed to be present within the composite molded body. A PP sheet (thickness: 1 mm) was attached to the surface using double-sided tape and an adhesive, to fabricate a three-dimensional composite sound absorbing material similar to Example 3-1. The results of evaluating the physical properties of the composite molded body and the sound absorption properties of the three-dimensional composite sound absorbing material are shown in Table 5.

### Comparative Example 3-1

A composite molded body was obtained by the same method as Example 3-1, except that fibrillated fibers B were used as the fibrillated fibers and the surface density was 25 g/m², similar to composite molded body R1. The results of evaluating the physical properties and sound absorption properties of the composite molded body are shown in Table 5.

### Comparative Example 3-2

A composite molded body was obtained by the same method as Example 3-1, except that fibrillated fibers D were used as the fibrillated fibers and the surface density was 100 g/m² similar to composite molded body R2. The results of evaluating the physical properties and sound absorption properties of the composite molded body are shown in Table 5.

### Comparative Example 3-3

A composite molded body was obtained by the same method as Example 3-1, except that fibrillated fibers B were used as the fibrillated fibers, the surface density was 100 g/m², and the solid weight ratio of the fibrillated fibers and staple fibers was 50:50, similar to composite molded body R3. The results of evaluating the physical properties and sound absorption properties of the composite molded body are shown in Table 5.

TABLE 1
Composite molded body properties and composite sound absorbing material sound absorption properties

| | | | Example | Example | Example | Example | Example | Example | Example |
|---|---|---|---|---|---|---|---|---|---|
| | | Units | 1-1 | 1-2 | 1-3 | 1-4 | 1-5 | 1-6 | 1-7 |
| Composite name | | — | S1 | S2 | S3 | S4 | S5 | S6 | S7 |
| Starting | Fibrillated fiber type | | A | A | A | A | A | B | C |
| material | Mean fiber size of | μm | 21 | 21 | 21 | 21 | 21 | 20 | 14 |
| | fibrillated fibers | | | | | | | | |
| | (Method A) | | | | | | | | |
| | Mean fiber size of | nm | 521 | 521 | 521 | 521 | 521 | 635 | 398 |
| | fibrillated fibers | | | | | | | | |
| | (Method B) | | | | | | | | |
| | Fibrillation rate | % | 0.85 | 0.85 | 0.85 | 0.85 | 0.85 | 0.89 | 0.46 |
| | Fibrillated | % | 8.2 | 8.2 | 8.2 | 8.2 | 8.2 | 7.2 | 23.5 |
| | fiber fineness | | | | | | | | |
| | Fibrillated | — | 20 | 20 | 20 | 30 | 10 | 20 | 20 |
| | fiber content | | | | | | | | |
| | Staple fiber type | — | PET | PET | PET | PET | PET | PET | PET |
| | Mean fiber size | μm | 3 | 7 | 3 | 3 | 3 | 5.3 | 3 |
| | of staple fibers | | | | | | | | |
| | Mean fiber length | mm | 3 | 5 | 3 | 3 | 3 | 3 | 3 |
| | of staple fibers | | | | | | | | |
| Processing method | | — | Wet | Wet | Wet | Wet | Wet | Wet | Wet |
| | | | papermaking | papermaking | papermaking | papermaking | papermaking | papermaking | papermaking |
| Composite | Surface density | g/m² | 50 | 50 | 100 | 50 | 150 | 50 | 100 |
| molded | Thickness | μm | 230 | 250 | 440 | 208 | 656 | 263 | 380 |
| body | Bulk density | g/cm³ | 0.22 | 0.20 | 0.23 | 0.24 | 0.23 | 0.19 | 0.26 |
| properties | Air permeability | s/100 mL | 0.20 | 0.10 | 0.30 | 0.20 | 0.60 | 0.40 | 2.10 |
| | resistance | | | | | | | | |
| | Air permeability | s/(100 | 0.87 | 0.40 | 0.68 | 0.96 | 0.91 | 1.52 | 5.53 |
| | resistance per | mL · mm) | | | | | | | |
| | unit thickness | — | | | | | | | |
| | Free-standing | | A | A | A | A | A | A | A |
| | property of | | | | | | | | |
| | composite | | | | | | | | |
| | molded body | | | | | | | | |
| | Fiber shedding | — | A | A | A | A | A | A | A |
| Sound | Peak frequency | — | 4130.00 | 4690.00 | 2550.00 | 3410.00 | 1980.00 | 2930.00 | 2240.00 |
| absorption | | | | | | | | | |
| property | Sound absorption | — | 0.94 | 0.95 | 0.90 | 0.95 | 0.85 | 0.99 | 0.96 |
| when | coefficient at | | | | | | | | |
| layered with | peak frequency | | | | | | | | |
| felt | Average sound | — | 0.74 | 0.75 | 0.68 | 0.72 | 0.64 | 0.65 | 0.49 |
| | absorption | | | | | | | | |
| | at 500-6400 Hz | | | | | | | | |

TABLE 2
Composite molded body properties and composite sound absorbing material sound absorption properties

| | | | Example | Example | Example | Example | Comp. | Comp. | Comp. |
|---|---|---|---|---|---|---|---|---|---|
| | | Units | 1-8 | 1-9 | 1-10 | 1-11 | Example 1-1 | Example 1-2 | Example 1-3 |
| Composite name | | — | S8 | S9 | S10 | S11 | R1 | R2 | R3 |
| Starting | Fibrillated fiber type | | B | B | B | B | B | D | B |
| material | Mean fiber size of | μm | 20 | 20 | 20 | 20 | 20 | 26 | 20 |
| | fibrillated fibers | | | | | | | | |
| | (Method A) | | | | | | | | |
| | Mean fiber size | nm | 635 | 635 | 635 | 635 | 635 | 39 | 635 |
| | of fibrillated | | | | | | | | |
| | fibers (Method B) | | | | | | | | |
| | Fibrillation rate | % | 0.89 | 0.89 | 0.89 | 0.89 | 0.89 | 2.42 | 0.89 |
| | Fibrillated | % | 7.2 | 7.2 | 7.2 | 7.2 | 7.2 | 90.8 | 7.2 |
| | fiber fineness | | | | | | | | |
| | Fibrillated | — | 5 | 5 | 5 | 30 | 20 | 20 | 50 |
| | fiber content | | | | | | | | |
| | Staple fiber type | — | PET | PET | PP | PET | PET | PET | PET |
| | Mean fiber size | μm | 3 | 3 | 5.3 | 3 | 3 | 3 | 3 |
| | of staple fibers | | | | | | | | |
| | Mean fiber length | mm | 3 | 3 | 2 | 3 | 3 | 3 | 3 |
| | of staple fibers | | | | | | | | |
| Processing method | | — | Wet | Wet | Wet | Wet | Wet | Wet | Wet |
| | | | papermaking | papermaking | papermaking | papermaking | papermaking | papermaking | papermaking |
| Composite | Surface density | g/m² | 100 | 300 | 300 | 50 | 25 | 100 | 100 |
| molded body | Thickness | μm | 410 | 960 | 1760 | 200 | 129 | 344 | 330 |
| properties | Bulk density | g/cm³ | 0.24 | 0.31 | 0.17 | 0.25 | 0.19 | 0.29 | 0.30 |
| | Air permeability | s/100 | 0.38 | 1.40 | 1.10 | 2.40 | 0.48 | 6.28 | 10.00 |
| | resistance | mL | | | | | | | |
| | Air permeability | s/(100 | 0.93 | 1.46 | 0.63 | 12.00 | 3.72 | 18.26 | 30.30 |
| | resistance per | mL · mm) | | | | | | | |
| | unit thickness | | | | | | | | |
| | Free-standing | — | A | A | B | A | B | A | A |
| | property of | | | | | | | | |
| | composite | | | | | | | | |
| | molded body | | | | | | | | |
| | Fiber shedding | | B | B | B | A | A | A | A |
| Sound | Peak frequency | — | 2430.00 | 1010.00 | 1180.00 | 2950.00 | 4690.00 | 2660.00 | 2710.00 |
| absorption | Sound absorption | — | 0.95 | 0.81 | 0.82 | 0.92 | 0.65 | 0.68 | 0.55 |
| property | coefficient at | | | | | | | | |
| when layered | peak frequency | | | | | | | | |
| with felt | Average sound | — | 0.69 | 0.31 | 0.40 | 0.55 | 0.40 | 0.40 | 0.34 |
| | absorption at | | | | | | | | |
| | 500-6400 Hz | | | | | | | | |

TABLE 3
Properties and evaluation of sound absorption properties of low frequency reinforced thin composite sound absorbing material

| | | | Example | Example | Example | Example | Example | Example | Example | Example |
|---|---|---|---|---|---|---|---|---|---|---|
| | | Units | 2-1 | 2-2 | 2-3 | 2-4 | 2-5 | 2-6 | 2-7 | 2-8 |
| Composite molded | No. | — | S1 | S1 | S2 | S2 | S3 | S3 | S5 | S6 |
| article (air | Thickness | μm | 230 | 230 | 250 | 250 | 440 | 440 | 656 | 263 |
| permeability- | Air permeability | s/(100 | 0.87 | 0.87 | 0.40 | 0.40 | 0.68 | 0.68 | 0.91 | 1.52 |
| modifying layer) | resistance per unit | mL · mm) | | | | | | | | |
| | thickness | | | | | | | | | |
| | Surface density | g/m² | 50 | 50 | 50 | 50 | 100 | 100 | 150 | 50 |
| Support | Support | | Felt | Felt | Felt | Felt | Felt | Felt | Felt | Felt |
| | Support thickness | mm | 8.00 | 8.00 | 8.00 | 8.00 | 8.00 | 8.00 | 8.00 | 8.00 |
| Composite sound | Number of | Number | 3 | 4 | 2 | 3 | 2 | 3 | 1 | 3 |
| absorbing | composite molded | | | | | | | | | |
| material | body layers | | | | | | | | | |
| | Air permeability- | mm | 0.69 | 0.92 | 0.50 | 0.75 | 0.88 | 1.32 | 0.66 | 0.79 |
| | modifying layer | | | | | | | | | |
| | thickness (total) | | | | | | | | | |
| | Composite sound | mm | 8.69 | 8.92 | 8.50 | 8.75 | 8.88 | 9.32 | 8.66 | 8.79 |
| | absorbing material | | | | | | | | | |
| | thickness | | | | | | | | | |
| | Total surface | g/m² | 150 | 200 | 100 | 150 | 200 | 300 | 150 | 150 |
| | density of composite | | | | | | | | | |
| | molded body layers | | | | | | | | | |
| | Total air | s/100 mL | 0.60 | 0.80 | 0.20 | 0.30 | 0.60 | 0.90 | 0.60 | 1.20 |
| | permeability | | | | | | | | | |
| | resistance | | | | | | | | | |
| | of composite | | | | | | | | | |
| | molded body layers | | | | | | | | | |
| | Peak frequency | Hz | 2120 | 1930 | 3290 | 2300 | 1790 | 1290 | 1980 | 1940 |
| | Sound absorption | — | 0.81 | 0.75 | 0.88 | 0.80 | 0.81 | 0.69 | 0.85 | 0.85 |
| | coefficient at | | | | | | | | | |
| | peak frequency | | | | | | | | | |
| | Sound absorption | — | 0.37 | 0.41 | 0.35 | 0.40 | 0.48 | 0.62 | 0.37 | 0.31 |
| | coefficient at | | | | | | | | | |
| | 1000 Hz | | | | | | | | | |
| | Average sound | — | 0.51 | 0.56 | 0.54 | 0.60 | 0.61 | 0.58 | 0.63 | 0.40 |
| | absorption at | | | | | | | | | |
| | 800-2000 Hz | | | | | | | | | |
| | Average sound | — | 0.67 | 0.61 | 0.75 | 0.70 | 0.58 | 0.42 | 0.64 | 0.48 |
| | absorption at | | | | | | | | | |
| | 500-6400 Hz | | | | | | | | | |

TABLE 4
Properties and evaluation of sound absorption properties of low frequency reinforced thin composite sound absorbing material

| | | | Example | Example | Example | Example | Example | Example |
|---|---|---|---|---|---|---|---|---|
| | | Units | 2-9 | 2-10 | 2-11 | 2-12 | 2-13 | 2-14 |
| Composite | No. | — | S8 | S8 | S9 | S10 | S1 | S1 |
| molded | Thickness | μm | 410 | 410 | 960 | 1760 | 230 | 230 |
| article (air | Air permeability resistance per | s/(100 | 0.93 | 0.93 | 1.46 | 0.63 | 0.87 | 0.87 |
| permeability- | unit thickness | mL · mm) | | | | | | |
| modifying | Surface density | g/m² | 100 | 100 | 300 | 300 | 50 | 50 |
| layer) | | | | | | | | |
| Support | Support | | Felt | Felt | Felt | Felt | Felt | Felt |
| | Support thickness | mm | 8.00 | 8.00 | 8.00 | 8.00 | 8.00 | 8.00 |
| Composite | Number of composite molded | Number | 2 | 3 | 1 | 1 | 1 | 2 |
| sound | body layers | | | | | | | |
| absorbing | Air permeability-modifying | mm | 0.82 | 1.23 | 0.96 | 1.76 | 0.23 | 0.46 |
| material | layer thickness (total) | | | | | | | |
| | Composite sound absorbing | mm | 8.82 | 9.23 | 8.96 | 9.76 | 8.23 | 8.46 |
| | material thickness | | | | | | | |
| | Total surface density of | g/m² | 200 | 300 | 300 | 300 | 50 | 100 |
| | composite molded body layers | | | | | | | |
| | Total air permeability resistance | s/100 mL | 0.76 | 1.14 | 1.40 | 1.11 | 0.20 | 0.40 |
| | of composite molded body layers | | | | | | | |
| | Peak frequency | Hz | 1600 | 1080 | 1010 | 1080 | 4130 | 2660 |
| | Sound absorption coefficient at | — | 0.82 | 0.83 | 0.81 | 0.82 | 0.94 | 0.87 |
| | peak frequency | | | | | | | |
| | Sound absorption coefficient at | — | 0.43 | 0.55 | 0.81 | 0.77 | 0.20 | 0.27 |
| | 1000 Hz | | | | | | | |
| | Average sound absorption at | — | 0.42 | 0.46 | 0.48 | 0.56 | 0.53 | 0.54 |
| | 800-2000 Hz | | | | | | | |
| | Average sound absorption at | — | 0.38 | 0.36 | 0.31 | 0.39 | 0.74 | 0.72 |
| | 500-6400 Hz | | | | | | | |

| | | | | | Comp, | Comp. | Comp. |
|---|---|---|---|---|---|---|---|
| | | | Example | Example | Example | Example | Example |
| | | Units | 2-15 | 2-16 | 2-1 | 2-2 | 2-3 |
| Composite | No. | — | S6 | S8 | R1 | R2 | R3 |
| molded | Thickness | μm | 263 | 410 | 129 | 344 | 330 |
| article (air | Air permeability resistance per | s/(100 | 1.52 | 0.93 | 3.72 | 18.26 | 30.30 |
| permeability- | unit thickness | mL · mm) | | | | | |
| modifying | Surface density | g/m² | 50 | 100 | 25 | 100 | 100 |
| layer) | | | | | | | |
| Support | Support | | Felt | Felt | Felt | Felt | Felt |
| | Support thickness | mm | 8.00 | 8.00 | 8.00 | 8.00 | 8.00 |
| Composite | Number of composite molded | Number | 6 | 6 | 1 | 1 | 1 |
| sound | body layers | | | | | | |
| absorbing | Air permeability-modifying | mm | 1.58 | 2.46 | 0.13 | 0.34 | 0.33 |
| material | layer thickness (total) | | | | | | |
| | Composite sound absorbing | mm | 9.58 | 10.46 | 8.13 | 8.34 | 8.33 |
| | material thickness | | | | | | |
| | Total surface density of | g/m² | 300 | 600 | 25 | 100 | 100 |
| | composite molded body layers | | | | | | |
| | Total air permeability resistance | s/100 mL | 2.40 | 2.28 | 0.48 | 6.28 | 10.00 |
| | of composite molded body layers | | | | | | |
| | Peak frequency | Hz | 1430 | 910 | 4690 | 2660 | 2710 |
| | Sound absorption coefficient at | — | 0.51 | 0.49 | 0.65 | 0.68 | 0.55 |
| | peak frequency | | | | | | |
| | Sound absorption coefficient at | — | 0.31 | 0.46 | 0.22 | 0.2 | 0.11 |
| | 1000 Hz | | | | | | |
| | Average sound absorption at | — | 0.39 | 0.32 | 0.28 | 0.25 | 0.18 |
| | 800-2000 Hz | | | | | | |
| | Average sound absorption at | — | 0.33 | 0.25 | 0.40 | 0.40 | 0.34 |
| | 500-6400 Hz | | | | | | |

TABLE 5
Properties and evaluation of sound absorption properties of three-dimensional composite sound absorbing materials

| | | | Example | Example | Comp. | Comp. | Comp. |
|---|---|---|---|---|---|---|---|
| | | Units | 3-1 | 3-2 | Example 2-1 | Example 2-2 | Example 2-3 |
| Composite molded article used | | — | S12 | S5 | R1 | R2 | R3 |
| Fibrillated fiber type | | — | Fibrillated PAN | Fibrillated PAN | B | D | B |
| | | | fibers | fibers | | | |
| Fibrillated fiber fineness | | % | 8.2 | 8.2 | 7.2 | 90.8 | 7.2 |
| Fibrillated fiber content | | — | 10 | 10 | 20 | 20 | 50 |
| Staple fiber type | | — | PET | PET | PET | PET | PET |
| Mean fiber size of staple fibers | | μm | 3 | 3 | 3 | 3 | 3 |
| Mean fiber length of staple fibers | | mm | 3 | 3 | 3 | 3 | 3 |
| Composite molded body molding | | — | Pulp molding | Wet | Wet | Wet | Wet |
| method | | | | papermaking → | papermaking | papermaking | papermaking |
| | | | | layering | | | |
| Surface density of composite | | g/m² | 150 | 150 | 25 | 100 | 100 |
| molded body | | | | | | | |
| Thickness of composite molded | | μm | 701 | 656 | 129 | 344 | 330 |
| body | | | | | | | |
| Bulk density of composite molded | | g/cm³ | 0.21 | 0.23 | 0.19 | 0.29 | 0.30 |
| body | | | | | | | |
| Air permeability resistance of | | s/100 mL | 0.58 | 0.60 | 0.48 | 6.28 | 10.00 |
| composite molded body | | | | | | | |
| Air permeability resistance per unit | | s/(100 mL · mm) | 0.83 | 0.91 | 3.72 | 18.26 | 30.30 |
| thickness of composite molded | | | | | | | |
| body | | | | | | | |
| Volume reduction | 1045.7 Hz | % | 69 | 72 | 88 | 82 | 78 |
| rate | 1478.9 Hz | % | 44 | 50 | 67 | 54 | 55 |
| | 1974.1 Hz | % | 25 | 28 | 48 | 35 | 29 |

### INDUSTRIAL APPLICABILITY

The composite molded body of the disclosure can be suitably used as an air permeability-modifying layer for a sound absorbing material and is easy to mold three-dimensionally, and it is therefore desirable for use as a composite sound absorbing material especially in buildings, automobiles and household appliances.

### REFERENCE SIGNS LIST

10 Three-dimensional composite sound absorbing material
11 PP sheet
12 Felt
13 Composite molded body
20 Sound source
30 Desk
40 Evaluator
50 Material tank
60 Slurry
61 Concentrated slurry
70 Metal mesh
80 Depressurization direction

1: A composite molded body comprising fibrillated fibers and staple fibers, wherein the composite molded body has a surface density of 30 g/m² to 1000 g/m² and an air permeability resistance per unit thickness of 15.0 s/(100 mL·mm) or lower.

2: The composite molded body according to claim 1, wherein the fibrillated fibers are one or more types selected from the group consisting of cellulose fine fibers, polyacrylonitrile fibrillated fibers, aramid pulp, chitin nanofibers, chitosan nanofibers and silk nanofibers.

3: The composite molded body according to claim 2, wherein the fibrillated fibers comprise cellulose fine fibers, and the cellulose fine fibers have a mean fiber size of 10 nm to 1000 nm, including microfibrous portions up to fibrillated ends.

4: The composite molded body according to claim 1, wherein the staple fibers are composed of synthetic fibers.

5: A method for producing a composite molded body according to claim 1, wherein the method includes a step of three-dimensional shaping of a slurry comprising fibrillated fibers and staple fibers, by a pulp molding method.

6: A method for producing a composite molded body according to claim 4, wherein the method includes a step of three-dimensional shaping of a slurry comprising fibrillated fibers and staple fibers, by a pulp molding method.

7: A sound absorbing material comprising a composite molded body according to claim 1.

8: A sound absorbing material comprising a composite molded body according to claim 4.

9: A composite sound absorbing material comprising a support having a thickness of 5 mm or greater, and a composite molded body according to claim 1, layered on the support.

10: A composite sound absorbing material comprising a support having a thickness of 5 mm or greater, and a composite molded body according to claim 4, layered on the support.

11: The composite sound absorbing material according to claim 9, wherein the support is a porous material.

12: The composite sound absorbing material according to claim 10, wherein the support is a porous material.

13: A composite sound absorbing material having a structure in which an air permeability-modifying layer and a porous material are layered, wherein:
the composite sound absorbing material has a thickness of 10 mm or smaller, and
in the method of measuring the normal incidence according to JIS A 1405, the material has a maximum for sound absorption at 3000 Hz or lower, a sound absorption coefficient of 0.3 or greater for 1000 Hz, an average sound absorption of 0.4 or greater for 800 Hz to 2000 Hz and an average sound absorption of 0.3 or greater for 500 Hz to 6400 Hz.

14: A composite sound absorbing material having a structure in which an air permeability-modifying layer and a porous material are layered, wherein:
the composite sound absorbing material has a thickness of 10 mm or smaller,
the air permeability-modifying layer has a surface density of 100 g/m² to 1000 g/m²,
the air permeability-modifying layer has an air permeability resistance of 0.1 s/100 mL to 2.0 s/100 mL,
the air permeability-modifying layer has a thickness of 0.50 mm to 5.00 mm, and
the porous material has a thickness of 5.00 mm or greater.
